(19) United States
(12) Patent Application Publication
(10) Pub. No.: US 2015/0006713 A1
(43) Pub. Date: Jan. 1, 2015

(54) High Performance Computing Network Activity Tracking Tool

(71) Applicant: Silicon Graphics International Corp., Fremont, CA (US)

(72) Inventors: Daniel Thomas, Paris (FR); John Baron, Burnsville, MN (US); Michael Andrew Raymond, Eagan, MN (US)

(21) Appl. No.: 13/930,955

(22) Filed: Jun. 28, 2013

(51) Int. Cl. H04L 12/26

(52) U.S. Cl. CPC H04L 43/0876
USPC 709/224

(57) ABSTRACT

A method and computer program product for tracking network activity within a high performance computing environment is disclosed An application may be run in the high performance computing environment and a computation within the application may be performed in parallel on more than one processor. When the application is executed, data is gathered about the performance of hardware devices within the high performance computing environment and the clocking signals are adjusted to a global clock. The temporal data may be processed for a hardware device for a defined time period to develop one or more temporal performance metrics.

Additionally, all activities that occur on a hardware device for a given time period can be determined and visualized.

### FIELD OF THE INVENTION

The invention generally relates to high performance computing and, more particularly, the invention relates to network activity tracking with a synchronized clock for high performance computing.

### BACKGROUND OF THE INVENTION

Procurement of high performance computing systems require the purchaser to analyze characteristics of the system to make a determination of the needed performance versus the cost for the system. Individual components of a high performance computing system including, the cores, switches, links, and interconnects each have their own performance characteristics. However, more codified system specific performance characteristics are needed in order to judge how the individual components interoperate as a whole. Thus, tools have been developed for measuring performance characteristics on a system level. In a similar fashion, designers of such high performance computing systems desire such tools to provide feedback in judging the performance of their designs.

For example, as supercomputing systems grow in scale and size the impact of the topology on the performance is a desired metric. Tools such as Prism exist that allow the display of the performance of MPI calls through

MpiPview, but cannot provide any topology information. Other tools are able to generate a communication matrix of the messages sent and received between each rank, however the information is independent of the process mapping.

Other software tools can obtain topology information about an HPC system. This topology information can be used for topology aware performance tools. Work at the Ohio State University by Hari Subramoni, Jerome Vienne, and Dhabaleswar Panda has resulted in a topology aware analysis module. The analysis module logs messages on intra-node and inter-node communication inside the MPI library and queries a topology detection service for identifying the layout of the processes on the network. Once messages logging has been completed, the communication profile for each rank is gathered. The messages are then classified based on the number of hops that are traversed. The data can be visualized. However, this provides information in relation to the network topology in general, but does not provide network activity for each network component.

### SUMMARY OF VARIOUS EMBODIMENTS

In accordance with one aspect of the invention, a method for tracking network activity within a high performance computing environment is disclosed. The high performance computing environment has a known topology and includes a plurality of nodes coupled together by a switching fabric. Each node is associated with one or more processors and each processor has an internal clock that produces a clocking signal. An application may be run in the high performance computing environment and a computation within the application may be performed in parallel on more than one processor. When the application is executed, data is gathered about the performance of hardware devices within the high performance computing environment. The hardware device may be host channel adapter, switch or link within the high performance computing environment for example. A time slot indicator and indicia of a hardware device are received as input for tracking activity on the hardware device. Thus, temporal information is gathered and may be processed to provide performance metrics for one or more hardware devices during the specified time period/time slots.

Traces for each rank are recorded including clocking information for the rank. For example, the transfer-begin time and the transfer-complete time may be recorded for a rank based upon the local clock signal. A global clock is then determined based upon one of the local clock signals. Thus, a clock adjustment for each rank is determined. The clock adjustment signal is relative to a clocking signal for one of the ranks, which is considered to be the global clock. The traces are then adjusted using the clock adjustment for each rank.

A data file can then be produced for the selected hardware device within the high performance computing environment for one or more time slots indicating events that occur during the time slot based upon one or more traces. The data file will indicate all of the events that occur during the specified time period that occur on the hardware device. The data file can be displayed on a display device and a histogram can be displayed of one or more metrics for the time slot(s) for the hardware device.

In order, to convert from rank information to hardware information, a topology map is obtained for the high performance computing environment. Additionally a listing of active ranks during the execution of the application is determined. This list of active ranks indicates where the various computations of the application are being computed within the high performance computing environment. The traces can be converted to add the hardware information from the topology map and the list.

The resulting data file may include a listing of each hardware component located between ranks and the listing includes events occurring during one or more designated time slots for these hardware components. For example, transfers between ranks may include transfers of data through HCAs, links, and switches.

In order to develop performance metrics for the time slot, all of the traces that have an ending time within the time slot must first be identified. After determining all of the traces, temporal performance metrics can be determined for the hardware device during the time slot.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows an exemplary high performance computing (HPC) environment that includes a plurality of cores, nodes, switches and switching fabric in a centralized parallel computing structure;

FIG. 2 shows a schematic for tracing raw activity data for ranks within the high performance computing environment;

FIG. 2A shows a mechanism for synchronizing clocking signals between ranks in the high performance computing environment;

FIG. 3 shows process steps for post processing trace data to obtain a synchronized global activity view of the trace data for hardware devices within the high performance computing environment;

FIG. 4 shows how statistics for a histogram time slot are calculated based upon a series of events that occur through a hardware device within the HPC system after the post processing; and

FIG. 5 shows an example of time slot prorating wherein an event partially occurs within a time period and data transfers can be ascribed to the partial time periods.

### DESCRIPTION OF ILLUSTRATIVE EMBODIMENTS

In illustrative embodiments, a method and computer program product are disclosed that allows for tracking network activity through a hardware device within a high performance computing system when an application is being executed. The present invention develops a synchronized clock signal for each of the hardware elements that contain clocking information and uses this synchronized clock to update time stamps that are part of traces that have been saved by a performance profiling tool that is operational during execution of the application. Activity tracking can then be viewed for one or more hardware devices over a period of time and characteristics about the performance of the particular hardware can be determined. For example, the average busy time for hardware device can be ascertained, the average concurrent number of transfers when the hardware is busy, the average achieved bandwidth, and histograms with defined sampling intervals for the metrics can be determined. This information can be used to judge the performance of an HPC system and to make adjustments to the application execution path for the processes of an application. This may be especially relevant if one or more hardware elements appear to be a performance bottleneck and therefore, some of the processes may be redirected. The present invention does not need to access counters/samples within the network in order to determine the activities for a time period that occur on one or more the hardware elements of the HPC system. Embodiments of the invention may use counter and sample data for visualization purposes without deviating from the intended scope of the invention.

Details of illustrative embodiments are discussed below.

Definitions. As used in this description and the accompanying claims, the following terms shall have the meanings indicated, unless the context otherwise requires:

“MPI” refers to the standard message passing interface along with the standard functions used in high performance computing systems as known to one of ordinary skill in the art.

“High performance computing” (“HPC”) refers to multi-nodal, multiple core, parallel processing systems wherein control and distribution of the computations is performed using a standard such as MPI.

“Performance profiling tool” is an application that allows for the capture of performance information about an HPC system when an application is run on the HPC system with test data. Performance profiling tools capture information such as execution time, send times and receive times, hardware counters, cycles, memory accesses and other MPI communications. The performance profiling tool collects this performance data and then can provide outputs including both text and graphs that provide a report of the performance of the HPC system.

“Activity” refers to a particular hardware element (HCA (“host channel adapter”, Switch, Switch port): An element is active when it is transferring data.

“Event” is a particular inter-node transfer. An event occurring due to an MPI rank A transfer leads to the writing of a record in the file trace.A. Each trace record generally contains the following information: start-time of the inter-node transfer, end-time of the transfer, target rank/CPU of the transfer, and the bytes transferred.

The term “process” shall mean a standard Unix process. In practice, an MPI application runs in the following context: an MPI rank executes a process and such process is mapped on a particular CPU. Thus, for the majority of contexts within this application the terms rank, process, and CPU are interchangeable.

The term “trace” shall be used in its ordinary context in HPC systems wherein a trace is a file that contains a set of records.

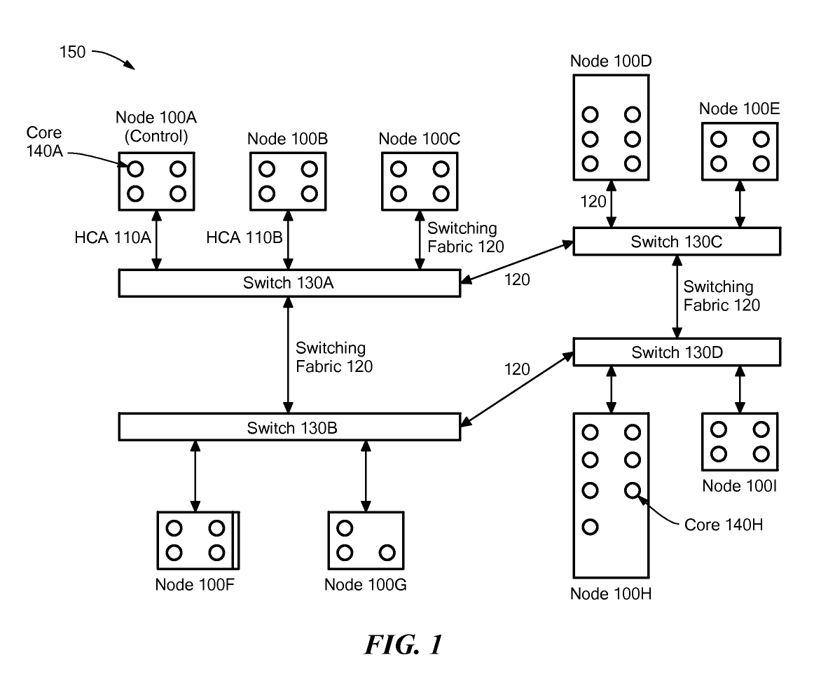

FIG. 1 shows an exemplary high performance computing (HPC) environment 150 that includes a plurality of cores 140A-H, nodes 100A-I, switches 130A-D and switching fabric 120 in a centralized parallel computing structure. As shown, there are nodes that link together one or more processing cores (e.g., Node 100A has four cores and Node 100D has six). The processing cores may be part of a multi-core processing structure (dual-core, quad-core, six-core etc.), such as central processing units made by such companies as Intel and AMD. A node may have more than one CPU and may share resources such as memory. FIG. 1 shows two types of nodes, a control or master node 100A (control) and computational nodes 100B-I.

In HPC environments Infiniband switching fabrics are employed, but other switching fabrics may be used including Gigabit Ethernet. For Infiniband (IB) switching fabrics, the Infiniband architecture defines a connection between processor nodes and high performance storage devices. At each end of the switching fabric is either a host bus adapter/host channel adapter HCA or a network switch. The switching fabric offers point-to-point and bidirectional serial links for coupling the processors to peripherals such as high-speed storage. The switches communicate with each other and transfer data and instructions between nodes and cores of the nodes. Communications in HPC environments are usually achieved using MPI.

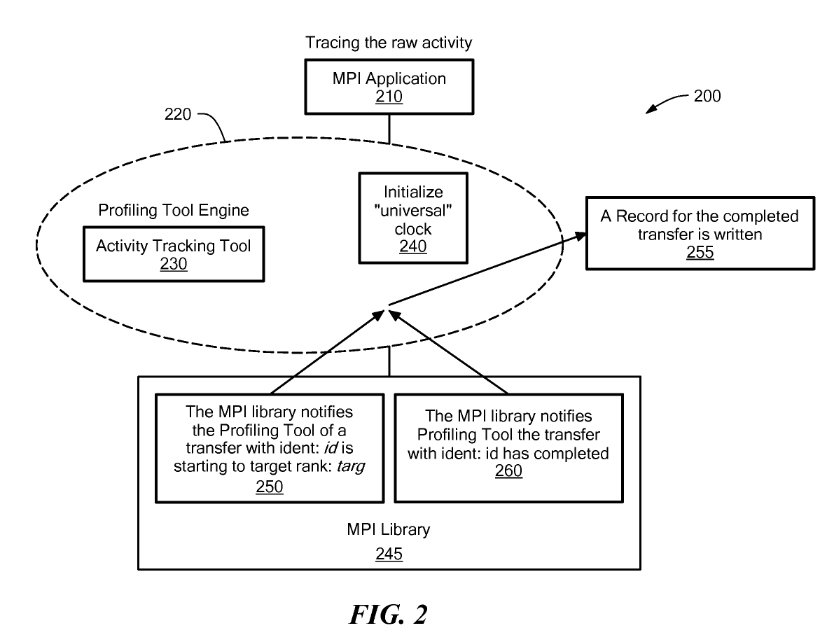

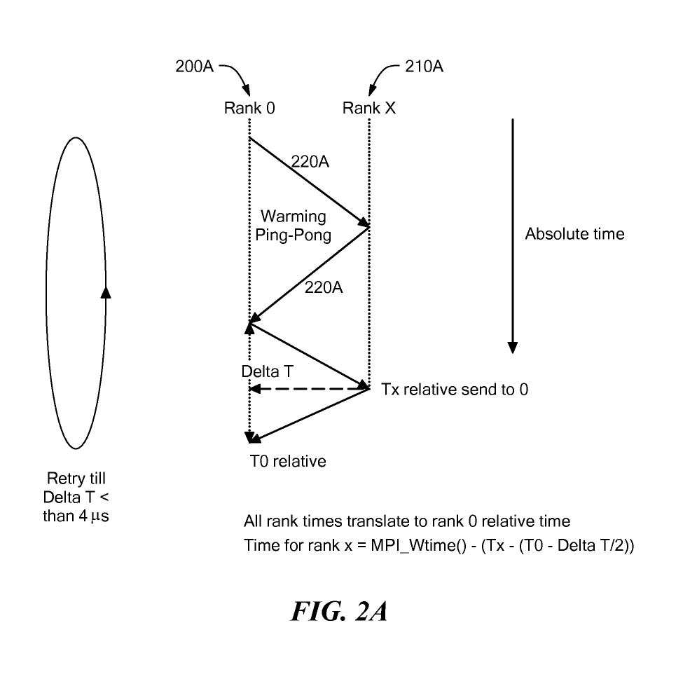

FIG. 2 shows a schematic 200 for tracing raw activity data during execution of an application on an HPC system. This schema is merely exemplary and other schema may be employed for extracting raw activity data.

An application 210 is executed such as an MPI application. The application 210 is initialized with a profiling tool 220 in the command line, such that the profiling tool 220 operates to record information about transactions within the HPC during the application. The profiling tool 220 includes an activity tracking tool 230 that uses the collected trace data and performs post processing to obtain time-based metric information about the performance of one or more hardware devices within the HPC system. When the application 210 is executed and the activity tracking tool 230 enabled either manually or automatically a time frame (group of time slots e.g. 100, 1 ms time slots) are selected and one or more hardware elements within the HPC system are selected for metric calculations by the activity tracking tool.

Additionally, at the beginning a universal clock is selected and calculations are made for augmenting the internal clocks of the other hardware elements within the HPC system 240. For example, the clock that is used to record send and receive times on each core is provided with an adjustment factor so that the clock is synchronized with the universal clock. The methodology for developing the synchronized clock will be explained in further detail with respect to FIG. 2A.

The profiling tool 220 collects data based upon MPI function calls within an application 210. This is achieved by the MPI library 245, which may be a dynamically linked library, notifying the profiling tool of a data transfer using a unique identifier ident for each transfer along with a target rank identifier, targ, that identifies the target device 250. Thus, timing about the beginning of the data transfer in accordance with the local clock time is saved to the record and the profiling tool adjusts the time based upon the synchronized clock. In a similar fashion the MPI library notifies the profiling tool that a transfer has completed providing the profiling tool with the MPI variable ident which contains the identifier for the transferred data 260. All of the data resulting from the notifications from the MPI library are stored in a record 255. It should be recognized that the profiling tool is not an essential part of the implementation; rather the tool could be any functional code that receives MPI notifications and writes the record to a trace file for a selected rank. For proper implementation purposes, in order to avoid the overhead of traces, the tool should track a small application window.

FIG. 2A shows a mechanism for synchronizing clocking signals between ranks. FIG. 2A shows Rank0 200A and RankX 210A, however this can be extended to a plurality of ranks.

First a data packet 220A is sent between Rank0 and RankX and back to Rank0. This first ping pong is used obtain initial timing information from each of the ranks. Additionally, this initial ping pong is used to tell Rank0 whether a satisfactory DeltaT has been reached. Preferably, the value of DeltaT should be less than 4 microsecond. It is known that the round trip transmission time for a data packet i.e. DeltaT should be less than 4 microseconds for a large Infiniband HPC system. Other times may be substituted based upon the round trip transmission time for specific applications that account for the components used and the size of the HPC system. Thus, the upper limit of DeltaT is used to provide an upper bound for the accuracy of the clock wherein the accuracy between ranks is equal to DeltaT/2 or 2 microseconds for the case of a typical Infiniband HPC system.

In the example shown, the absolute time is set relative to Rank0. Thus, all rank time are translated to Rank0 relative time (e.g. the internal clock of Rank0). A time for RankX therefore is translated based upon the following formula:

Time for RankX=MPI_{—}Wtime( )−(Tx−(T0−Delta T/2))

It should be recognized that DeltaT and T0 are local Rank0 measurements. Tx is included in the ping pong packet that is returned to Rank0.

Once Rank0 has collected Tx, T0 and DeltaT, Rank0 can send the value of (Tx−(T0−Delta T/2)). The record times of the traces can then be adjusted from the raw time of the internal clock of RankX to the new synchronized clock time relative to Rank0 time.

Provided below is an example calculation between Rank0 and RankX:

| Rank0 | RankX |
|---|---|
| send a 1001(rank 0 local time) | receive |
| Sync point<------------------ | send at Tx = 1023(rank X local time) |

receive a 1004 (rank 0 local time)
DeltaT=3
T0−DeltaT/2=1004−1.5=1002.5
Tx−(T0−DeltaT/2)=20.5 This represents the amount of time rank x clock is in advance from rank 0 clock.

A factor of Tx−(T0−DeltaT/2) is provided to each rank and the timing data stored within the records as recorded by the profiling tool are updated with this factor.

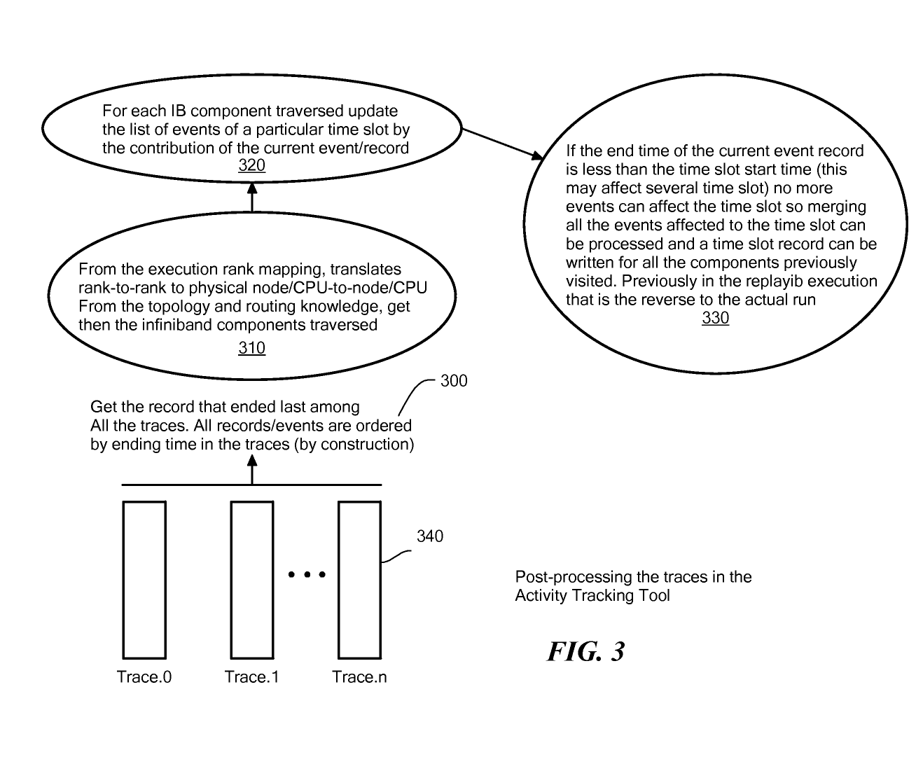

FIG. 3 shows process steps for post processing trace data to obtain a synchronized global activity view of the trace data using the activity tool with the trace data updated in accordance with the synchronized clock as explained with respect to FIG. 2A. Other synchronization methods may be employed as are known in the art to synchronize the internal clock signals for each of the ranks of interest.

For a run of the application, the activity tracking tool will process the trace files containing records of data transfers and data transfer completions for a rank according to the selected or automatically selected parameters for the activity tracking tool. (e.g. the time range for tracking traces, and the ranks to obtain performance metric information for the time range).

The activity tracking tool sorts all of the records for the traces to determine the record that ended last among all of the records 300. This is shown in the figure wherein the records are represented as rectangles 340 and the records are sorted into a trace order from trace 0 to trace n wherein the traces are in reverse ending time order.

From the traces and corresponding record information (rank-to-rank data transfer information), the profiling tool translates the rank-to-rank mapping to a physical mapping of node/CPU-to-node/CPU i.e. the physical components traversed between the ranks 310. In order to perform the rank to physical mapping, the profiling tool gathers topology and routing information about the application. The standard OFED commands “ibnetdiscover” and “ibroute” can be used to obtain the topology and routing information respectively. Topology indicates the actual physical interconnection of cores, HCAs, links, switches and switching fabric within the entire HPC system. Thus, FIG. 1 would provide exemplary topology information. Whereas the routing information is application and execution specific. Thus, processes within an application can be routed in many different ways within the same HPC system, depending on the set of nodes on which the application runs. From the topology and routing information the components traversed between ranks can be obtained.

Next for each component that is traversed, the list of events for a particular time slot are updated with the contribution of the current event 320. For example, an HCA may be traversed during a send and receive cycle between ranks. Thus, the HCA would be updated as being active for each time slot between the send and receive times.

The profiling tool then determines if the end time of the current event record is less than the time slot start time for all records within that time slot for the given hardware. If this is true, none of the other records affect the time slot and the time slot can be processed to determine relevant metrics 330.

For example, assume three trace files wherein the number represents the ending time for each record within the trace:

| Trace0 | Trace1 | Trace3 |
|---|---|---|
| 00001 | 00002 | 00004 |
| 00005 | 00011 | 00008 |
| 00010 | | 00010 |
| | | 00015 |

Thus, the order of treatment would be Trace3 and the record for the event that ends at 00015. The remaining records would be processed in the following order: Trace1 00011, Trace3 00010, Trace0 000010, Trace3 00008, Trace0 00005, Trace1 00002, and T0 00001.

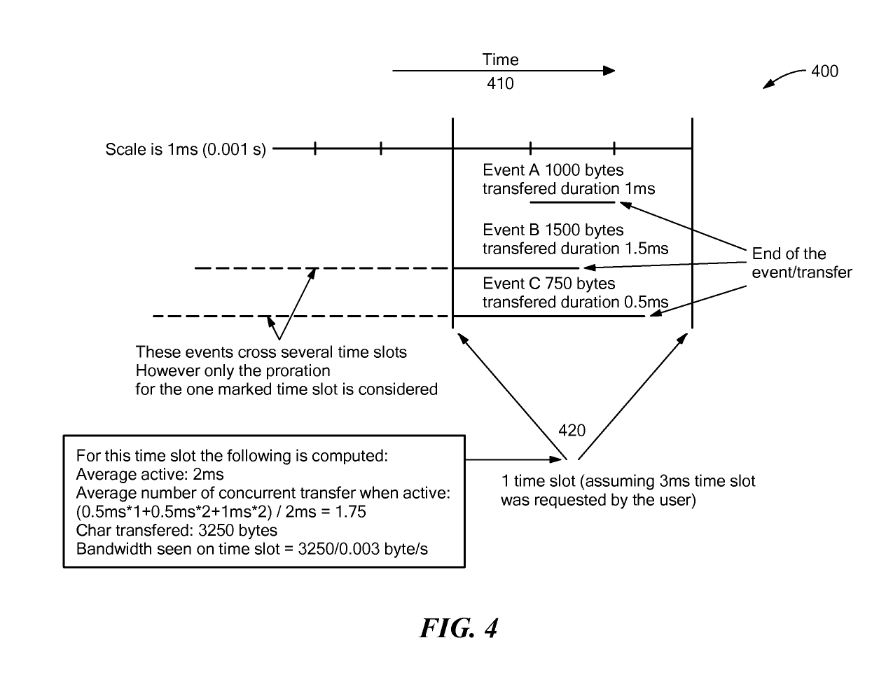

FIG. 4 shows a histogram 400 that is developed based upon a series of events (EventA, EventB, EventC) that occur through a hardware device within the HPC system after the post processing step described with respect to FIG. 3. For this histogram, time 410 moves from left to right. The histogram 400 assumes that a user of the activity tracking tool has requested to view the events that occur on the hardware for a given time period. In this example, the time period is one time slot 420 and the slot is 3 ms in length. Events A B and C each have an end of event/transfer time that falls within the time slot. For event A, 1000 bytes are transferred during 1 ms of the 3 ms time slot. Event B ends at approximately 1.5 ms into the time slot and 1500 bytes are transferred. For event C 750 bytes are transferred during the duration of 0.5 ms of the time slot. Event A occurs completely within the time slot (start and end times), while events B and C end during the time slot, but begin during a previous time slot. Given that there are no other events that occur during the time slot, the time slot can be processed to determine various metrics. For example:

The average active time is 2 ms;

The average number of concurrent transfers when active is 1.75;

The total number of characters transferred is 3250 bytes; and

The bandwidth seen during the time slot is 1.0833×10⁶ bytes/sec.

Various metrics for hardware elements for a given time slot can be determined. These metrics include: the average busy time for the hardware, average concurrent number of transfers when busy, the average bandwidth achieved when busy, and histograms for the sampling intervals for these events.

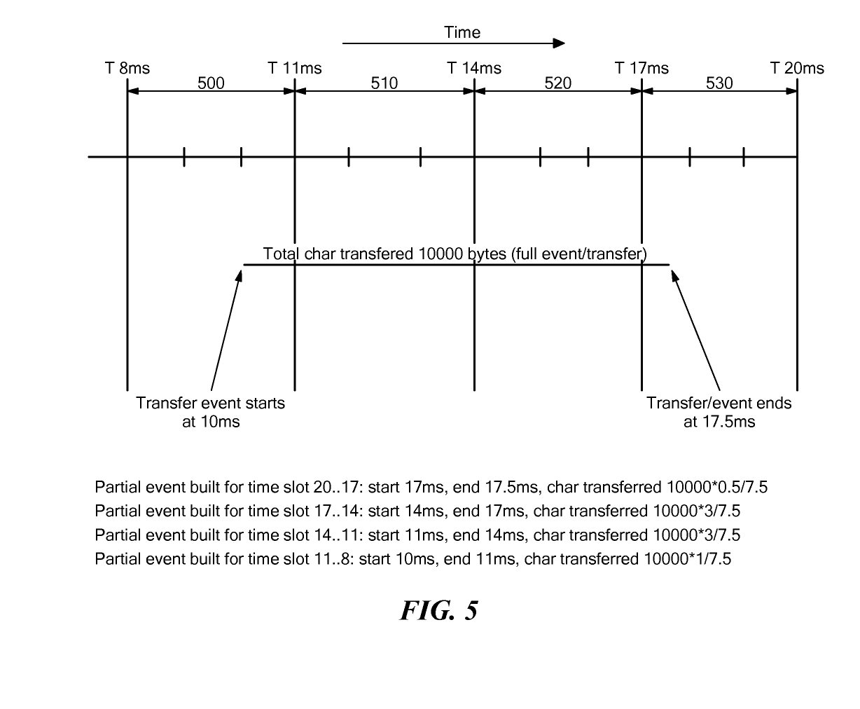

Activities can be ascribed to partial time slots. As shown in FIG. 5 an activity is at least partially active during four time slots 500, 510, 520, 530. In this example, the event begins at 10 ms and ends at 17.5 ms where 10000 total characters are transferred. For this event, data is transferred between RankX and RankY. The event is partially active in the 20 ms time slot 530, wherein the number of characters transferred during the 20 ms time slot 530 is 666 bytes. Similarly, the amount of bytes transmitted during the 17 ms, 14 ms, and 11 ms time slots 520, 510, 500 can also be calculated. Activity and data transferred through hardware can also be ascribed to hardware that resides between rank elements based upon the known topology and the routing of processes. For example, assume that a transfer/event from RankX to RankY uses the path HCA_A, Switch A port 29, Switch B port 29, HCA_B and that the transfer start time is 10 ms ends at time 17.5 ms and during this 7.5 ms time 10000 bytes are transferred as shown in FIG. 5 For all the component is the path (HCA_A—Switch A port 29—Switch B port 29—HCA B) the time slot lists may be updated and indicia may be included to indicate that these hardware elements are active during this 7.5 ms event.

It should be recognized by one of ordinary skill in the art that the above described figures are exemplary and that variations of the histograms and rank connections, HPC topology etc. can be made without changing the scope of the invention. For example, histograms can be combined for multiple hardware elements for a given time slot and time slots can be added to a histogram to show the events as they traverse and cause activity on the hardware devices in the HPC system.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system. The processes described above are merely exemplary and it is understood that various alternatives, mathematical equivalents, or derivations thereof fall within the scope of the present invention.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

Although the above discussion discloses various exemplary embodiments of the invention, it should be apparent that those skilled in the art can make various modifications that will achieve some of the advantages of the invention without departing from the true scope of the invention.

What is claimed is:

1. A method for tracking network activity within a hardware device in a high performance computing environment having a known topology including a plurality of nodes coupled together by a switching fabric, each node associated with one or more processors, each processor having an internal clocking signal and associated with a rank, wherein an application may be run in the high performance computing environment and a computation within the application may be performed in parallel on more than one processor, the method comprising:
executing instructions stored in memory wherein execution of the instructions by at least one processor in the high performance computing arrangement causes the processor to:
record traces for each rank based upon the clock signal for the rank;
determine a clock adjustment for each rank relative to a clocking signal for one of the ranks and adjusting the traces using the clock adjustment for each rank;
produce a data file for a hardware device within the high performance computing environment for one or more time slots indicating occurring events during the time slot based upon one or more traces.

2. The method according to claim 1 further comprising:
displaying the data file on a display device.

3. The method according to claim 2 wherein the data file is displayed as a histogram showing activity for the hardware device within one or more time slots.

4. The method according to claim 1, wherein one or more of the processors:
obtain topology of the high performance computing environment;
obtain a listing of active ranks for the execution of the application; and
convert the traces to include a hardware mapping of events based upon the topology and the listing of active ranks.

5. The method according to claim 4 wherein the data file includes a listing of each hardware component located between ranks and the listing includes events occurring during one or more designated time slots.

6. The method according to claim 1, further comprising:
receiving as input one or more time slots and hardware devices in the high performance computing environment to include in the data file.

7. The method according to claim 1, wherein reach rank is associated with a computer core.

8. The method according to claim 1 wherein each trace includes at least a start of transfer time and an end of transfer time.

9. The method according to claim 1 wherein one or more of the processors determine for a predetermined time slot and hardware device all of the traces that have an ending time within the time slot;
after determining all of the traces that have an ending time within the time slot, calculating one or more metrics for the time slot.

10. The method according to claim 9, wherein the one or more metrics may include the bandwidth used by the hardware device during the time slot.

11. A computer program product including a non-transient computer readable medium having computer code thereon for tracking network activity within a high performance computing environment including a plurality of processors, each processor having an internal clocking signal, the computer code comprising:
computer code for recording traces for each rank based upon the clock signal for the rank;
computer code for determining a clock adjustment for each rank relative to a clocking signal for one of the ranks and adjusting the traces using the clock adjustment for each rank;
computer code for producing a data file for a hardware device within the high performance computing environment for one or more time slots indicating occurring events during the time slot based upon one or more traces.

12. The computer program product according to claim 11 further comprising:
computer code for displaying the data file on a display device.

13. The program product according to claim 12 wherein the data file is displayed as a histogram showing activity for the hardware device within one or more time slots.

14. The computer program product according to claim 11, further comprising:
computer code for obtaining topology of the high performance computing environment;
computer code for obtaining a listing of active ranks for the execution of the application; and
computer code for converting the traces to include a hardware mapping of events based upon the topology and the listing of active ranks.

15. The computer program product according to claim 14 wherein the data file includes a listing of each hardware component located between ranks and the listing includes events occurring during one or more designated time slots.

16. The computer program product according to claim 11, further comprising:
computer code for receiving as input one or more time slots and hardware devices in the high performance computing environment to include in the data file.

17. The computer program product according to claim 11, wherein reach rank is associated with a computer core.

18. The computer program product according to claim 11 wherein each trace includes at least a start of transfer time and an end of transfer time.

19. The computer program product according to claim 11 further comprising:
computer code for determining for a predetermined time slot and hardware device all of the traces that have an ending time within the time slot;
computer code for calculating one or more metrics for the time slot after all of the traces that have an ending time with the time slot.

20. The computer program product according to claim 19, wherein the one or more metrics may include the bandwidth used by the hardware device during the time slot.
